(19) United States
(12) Patent Application Publication
(10) Pub. No.: US 2016/0363711 A1
(43) Pub. Date: Dec. 15, 2016

(54) LIGHTING SYSTEM WITH IMPROVED ILLUMINATION DISTRIBUTION AND OUTPUT LUMINANCE VARIATION

(71) Applicant: GENERAL ELECTRIC COMPANY, Schenectady, NY (US)

(72) Inventors: Mark Marshall Meyers, Mechanicville, NY (US); Paul Richard Myers, Clifton Park, NY (US); Masako Yamada, Niskayuna, NY (US); Scott Michael Miller, Clifton Park, NY (US); Siavash Yazdanfar, Niskayuna, NY (US)

(21) Appl. No.: 14/736,081

(22) Filed: Jun. 10, 2015

(51) Int. Cl. F21V 8/00; F21K 99/00

(52) U.S. Cl. CPC G02B 6/0023; G02B 6/0036; G02B 6/0038; G02B 6/0068; G02B 6/0088; F21K 9/30

(57) ABSTRACT

Waveguides having improved illumination distribution and output luminance variation and lighting systems utilizing such waveguides are disclosed. The lighting systems generally include a light source which is optically coupled to a waveguide to distribute the light. The waveguides include one or more headlighting reduction regions and one or more output intensity shaping regions that work together to improve the distribution of light and reduce the effects of headlighting. The headlighting reduction regions may be integrated with the output intensity shaping region or may be an independent section.

### BACKGROUND OF THE INVENTION

The subject matter disclosed herein relates generally to lighting systems, and more specifically, to lighting systems having improved illumination distribution and output luminance variation.

Area lighting is typically found in homes, office spaces, warehouses, storage areas, museums, trade centers and commercial spaces, for example. One continually developing technology employed for area lighting applications is lighting systems utilizing light emitting diodes (LEDs). LED-based lighting systems are increasingly used to replace conventional fluorescent and incandescent lighting systems. LED-based lighting systems may provide a longer operating life, high luminous efficacy, and improved manufacturability at lower costs. However, conventional LED-based lighting systems may not be optimal for all area lighting applications and certain characteristics, such as illumination distribution and output luminance, provide additional unique design considerations that may be particularly related to LED-based lighting systems. LED-based lighting designs often face a tradeoff between the ability to provide a tailored output distribution or a pleasing aesthetic design.

For instance, for LED-based lighting systems, a lighting fixture configured to be placed on a ceiling may include a linear array of LEDs arranged in a long narrow pattern. The LEDs may be optically coupled to a long narrow waveguide oriented vertically with respect to the ceiling to distribute light coupled into the narrow edge of the waveguide over a wide area (e.g., a room). The LEDs may be arranged in a linear array with a center-to-center spacing that is larger than the size of the LEDs. If a linear array of LEDs is coupled into the narrow edge of a waveguide, and the sides of the waveguide are patterned with micro-optical features, the luminous output from the waveguide surface will exhibit banding. Areas in line with the LED will be brighter, while areas between the LEDs will be darker. The observability of this phenomena will depend on the size of the emission area of the LED, the spacing between the LEDs, and the details of the waveguide surface patterning. This phenomena is often referred to as “headlighting,” since the modulation of the luminance looks similar to car headlights projected in fog. Headlighting is generally undesirable for general area lighting applications. In addition to the desirability for reduced headlighting by filling the observable gaps in output luminance, general improvements in light uniformity are also desirable.

### BRIEF DESCRIPTION OF THE INVENTION

In one embodiment, a waveguide is provided. The waveguide includes at least one headlighting reduction region configured to reduce the magnitude of luminance modulation from the waveguide. The waveguide further includes at least one output intensity shaping region configured to increase the uniformity of light distribution from the waveguide.

In another embodiment, a system is provided. They system includes a light source and a waveguide. The waveguide is arranged to receive light from the light source at a horizontally positioned surface and distribute the light through a vertically positioned surface. The waveguide includes at least one headlighting reduction region configured to reduce the magnitude of luminance modulation from the waveguide. The waveguide further includes at least one output intensity shaping region configured to increase the uniformity of light distribution from the waveguide.

In another embodiment, a method of providing general area lighting for a room is provided. The method includes emitting light from a light source into a patterned waveguide. The method further includes forming a plurality of secondary images of the light source within the waveguide. The method further includes reflecting at least some of the light within the waveguide off of patterned major surfaces of the waveguide. The method also includes emitting the light from the patterned major surfaces of the waveguide into the room.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a lighting system in accordance with embodiments of the present invention.

FIG. 2 is a more detailed view of the lighting system, in accordance with embodiments of the present invention.

FIG. 3 illustrates a cross-sectional view of the lighting system illustrated in FIG. 2 and taken along the cut lines 3-3, in accordance with one embodiment of the present invention.

FIG. 4 is a perspective view of a waveguide exhibiting the headlighting effect.

FIG. 5 is a perceptive view of a waveguide that may be employed in a lighting system in accordance with embodiments of the present invention.

FIG. 6 is an end view of the waveguide of FIG. 5 that may be employed in a lighting system in accordance with embodiments of the present invention.

FIG. 7 is an end view of a waveguide that may be employed in a lighting system in accordance with alternative embodiments of the present invention.

FIG. 8 is a perspective view of a waveguide that may be employed in a lighting system in accordance with alternative embodiments of the present invention.

### DETAILED DESCRIPTION OF THE INVENTION

Embodiments of the invention include a novel optical technique which reduces the magnitude of the luminance modulation (headlighting) of light which exits the major surfaces of a waveguide in a luminaire or lighting system. By applying optical patterns to a large area of the waveguide, the headlighting phenomena can be eliminated or reduced to an acceptable level, while allowing the remainder of the waveguide to function as desired. As previously described, light fixtures that utilize linear arrays of individual lights, such as LEDs, which are optically coupled to the edge of a waveguide can exhibit banding in the luminous output from the major surfaces of the waveguide. This banding of the luminous output can be objectionable to observers in the room. This is especially true when nominally clear waveguides are used to distribute the light from the luminaire. Light fixtures with clear waveguides which appear transparent when turned off are potentially attractive to customers. However, if they exhibit strongly observable banding when illuminated, this can be objectionable. As described in detail below, present embodiments reduce or eliminate the appearance of banding in the output intensity distribution, by forming multiple, displaced images of the LED sources within the waveguide, which act as secondary emitters, whose output is summed with the direct emission from the LEDs to form a more uniform output from the surface of the waveguide and the luminaire. Thus, the disclosed lighting systems provide a high quality, controlled light distribution with a uniform output from the major surfaces of the waveguide, while using a linear array of discrete, non-overlapping LEDs as sources.

In general, the lighting systems described herein operate to form multiple, displaced, secondary images of the LED sources within the waveguide, by reflecting the light off of micro-optical reflective features (e.g., vertically oriented features) before the light is transmitted out of the waveguide. Light from the secondary images created by the micro-optical features then acts to fill in the gaps in output luminance in the area below the LED. There are several ways that this approach can be implemented, as will be described in detail below. The lighting systems generally include a light source, such as a linear array of LEDs, which is optically coupled to a waveguide to distribute the light. The presently described waveguides include one or more headlighting reduction regions and one or more output intensity shaping regions that work together to improve the distribution of light and reduce the effects of headlighting. The headlighting reduction regions may be integrated with the output intensity shaping region or may be an independent section. Advantageously, the described lighting systems exhibit improved uniformity in output luminance and distribution, with reduced visible banding (headlighting).

In one embodiment, the micro-optical features of the headlighting reduction region include convex or concave cylindrical surfaces which form real or virtual images of the LED sources whose output is summed with the directly emitted light from the LEDs. In this embodiment the headlighting reduction region includes vertically oriented cylindrical micro-optical features formed as a separate region from the output intensity shaping region which is formed throughout the remainder of the waveguide. Another embodiment of the invention utilizes a series of micro-prisms to generate the output intensity distribution, where the apex of the prisms have been modified by a secondary machining step which forms concave cylindrical features on the tops of the microprisms. This embodiment may be advantageous in that the headlighting reduction region is not separate from (i.e., is integrated with) prismatic features of the output intensity distribution region. Another embodiment involves applying a vertical or horizontal (lateral) high frequency modulation of the waveguide with a sinusoidal or other periodic pattern. This causes dispersion of the light rays as they propagate within the waveguide, while linear ramp sections of the prisms of the waveguide provide the output intensity distribution control. This embodiment also combines or integrates the headlighting reduction and output shaping features in the same patterned area on the waveguide. These embodiments, and others, will be described in greater detail below.

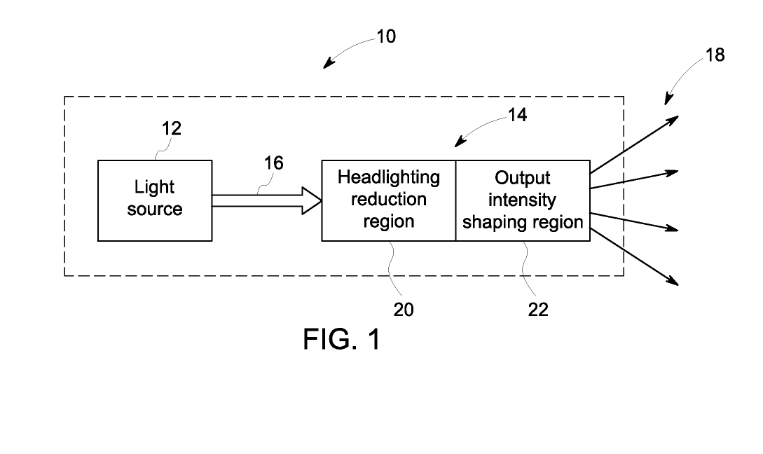

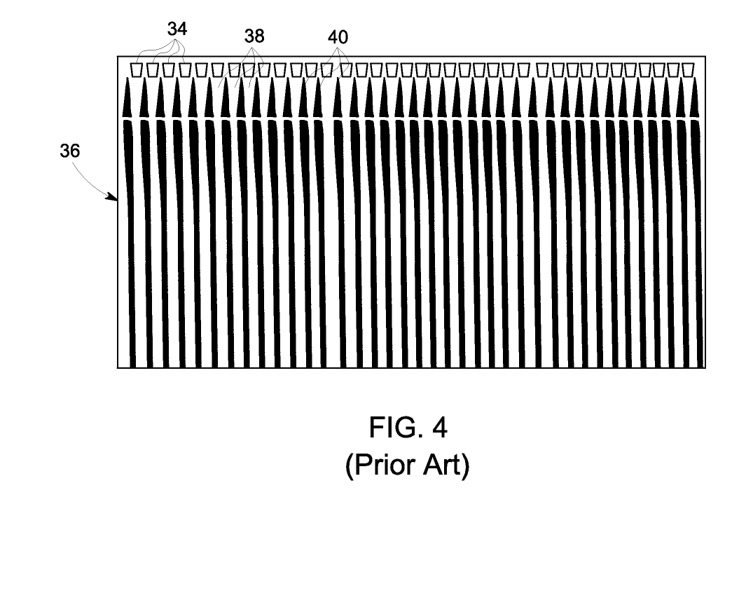

Turning now to the figures and referring initially to FIG. 1, a block diagram of a lighting system 10 in accordance with embodiments of the present invention is illustrated. The lighting system 10 is configured for use in general area lighting applications, such as overhead room lighting. The lighting system 10 includes a light source 12 and a waveguide 14. As will be appreciated, the light source 12 is optically coupled to the waveguide 14 such that the waveguide 14 receives light 16 from the light source 12 and distributes the light 18 into the ambient surroundings. As will be illustrated in more detail below, the waveguide 14 is arranged vertically with respect to the ceiling and underlying floor. The waveguide 14 is arranged to distribute the light from the light source 12. The light source 12 may include a plurality of LEDs, for instance. In accordance with embodiments described herein, the waveguide includes a headlighting reduction region 20 for reducing the headlighting effect from the linearly placed LEDs in the light source 12. The headlighting phenomena will be illustrated and described with reference to FIG. 4, below. The waveguide 14 also includes an output intensity shaping region to aid in optimizing the light distribution in the room.

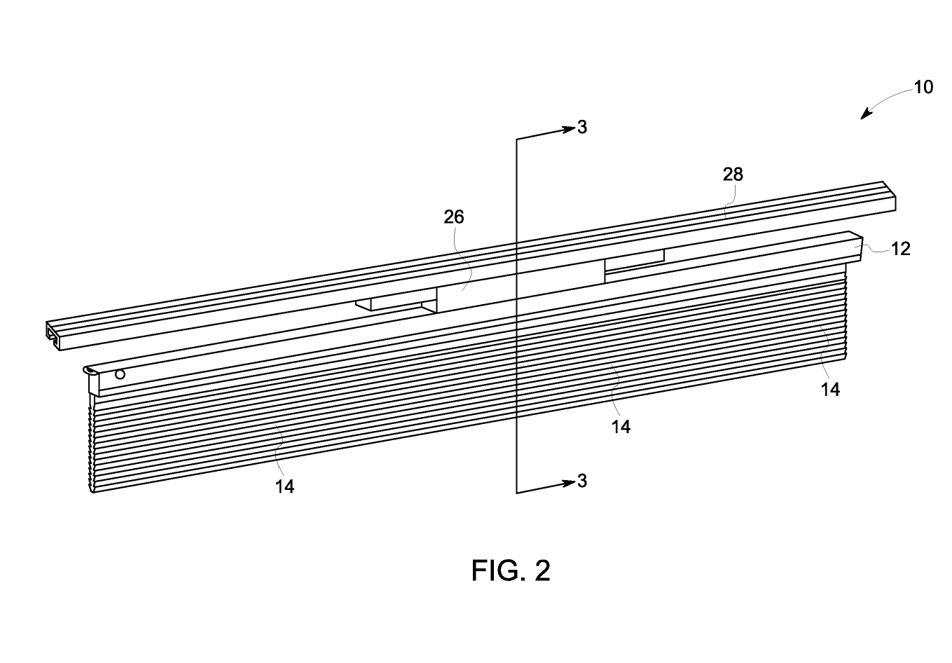

Referring now to FIG. 2, a perspective view of the lighting system 10 configured in accordance with one embodiment of the present invention is illustrated. As previously described, the lighting system 10 generally includes a waveguide 14 configured to distribute light in a controlled pattern to maximize the uniformity of the illumination by shaping the output intensity distribution and further configured to reduce headlighting by forming secondary images within the waveguide 14 to fill the undesirable gaps in output luminance that would otherwise appear between individual lights of the light source 12. In the illustrated embodiment, the lighting system 10 includes a single waveguide 14. As will be appreciated, the number of waveguides 14 may vary from a single waveguide 14 to any desirable number of waveguides 14 to extend to a desired system length. While a single “waveguide 14” is generally described in the application for simplicity, embodiments of the present invention are not limited as such, and the lighting system 10 may include one or more waveguides 14 arranged linearly, end-to-end. As will be discussed in greater detail below, the waveguide 14 may be optimized by including one or more headlighting reduction regions 20 and one or more output intensity shaping regions 22, in accordance with embodiments of the invention.

As previously described, the waveguide 14 is coupled to a light source 12 configured to produce light for distribution through the waveguide 14. In one embodiment, the light source 12 may include a number of LEDs arranged in a row along the entire length of the lighting system 10 such that each LED of the light source 12 produces light directed downward into the waveguide 14 for distribution into a room. As will be appreciated, specific types of LEDs, such as organic LEDs or alternative illumination devices may also be employed in the light source 12 to illuminate the waveguide 14 in accordance with embodiments of the present invention. The light source 12 may include a number of other elements, such as clips, heatsinks, and reflectors, for example, as will be appreciated by those skilled in the art.

The lighting system 10 may further include an electrical box 26. The electrical box 26 may provide power to the light source 12. As will be appreciated, the electrical box 26 may include driver components, electrical and mechanical adapters, mechanical retainer structures, terminal blocks, and other electrical and mechanical components configured to provide power to the light source 12. The electrical box 26 also includes components to mechanically secure the elements within the electrical box 26 and to mechanically secure the light source 12 to a mounting mechanism 28. The mounting mechanism 28 may be any mechanical structure configured to couple the light source 12, electrical box 26 and waveguide 14 to an overhead region such as a ceiling or arm extending from a wall, such as a bracket, post, brace, shoulder, step or recess, for example. As will be appreciated, alternative configurations of the electrical box 26 in the mounting mechanism 28 may be employed. That is, any suitable components may be employed in the electrical box 26 or the mounting mechanism 28 such that the lighting system 10 may be arranged and secured to an overhead region such that adequate power is provided to the light source 12 for distribution in the optically patterned waveguide 14. Further, in some embodiments, the components of the light source 12, electrical box 26 and/or mounting mechanism 28 may be combined with one another such that they are contained within a single housing.

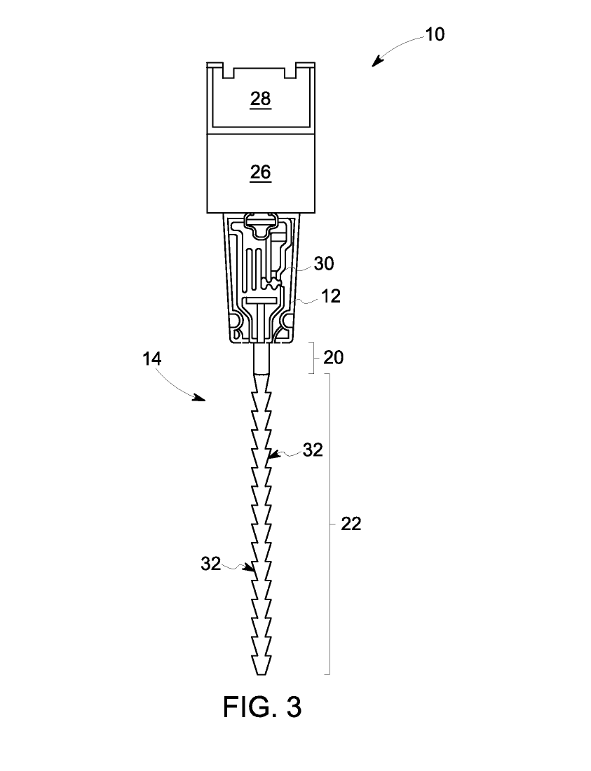

Referring now to FIG. 3, a cross-sectional view of the lighting system 10 taken along the cut-lines 3-3 of FIG. 2 is illustrated. As previously described, the lighting system 10 includes any suitable mounting mechanism 28 that may be used to couple the lighting system 10 to an overhead region such as a ceiling or arm extending to an overhead region. The mounting mechanism 28 may be coupled directly to the electrical box 26 configured to provide mechanical support and electrical signals to the light source 12. The light source 12 may include a plurality of LEDs 30 that may be arranged along the length of the lighting system 10. As illustrated in FIG. 3, the LED 30 is sized and configured to provide light to the waveguide 14 which may be optically coupled to the light source 12. Specifically, the light source 12 provides illumination in a downward direction into the waveguide 14. As described further below, the waveguide 14 may include at least one headlighting reduction region 20 and at least one output intensity shaping region 22. In the simplified embodiment of FIGS. 2 and 3, there is one headlighting reduction region 20 which is optically coupled between the light source 12 and the output intensity shaping region 22. In the illustrated embodiment, the headlighting reduction region 20 is arranged at the top of the waveguide 14 and is configured to receive light directly from the light source 12. In one embodiment, the headlighting reduction region 20 includes a number of vertically oriented cylindrical micro-optic features having concave or convex cylindrical surfaces. The cylindrical features of the headlighting reduction region 20 are sized and shaped such that the real or virtual images which are formed are summed with the direct light 16 from the light source 12. In this way, the gaps in output luminance that might normally be formed in the surfaces of the waveguide may be improved. This undesirable headlighting phenomena will be described and illustrated below with respect to FIG. 4.

In the illustrated embodiment, the output intensity shaping region 22 includes a number of stacked prismatic features. That is, as illustrated in the cross-sectional view of the waveguide 14 of FIG. 3, the output intensity shaping region 22 has been patterned such that each side or major surface 32 of the waveguide includes a repeating pattern of planar trapezoidal prisms. The planar trapezoidal prisms are aligned to the horizontal plane. After each horizontally-oriented divergent planar edge, the vertical portion is patterned such that the planar trapezoidal prism pattern can begin again. These prisms have a base which is from approximately 1.5 mm to 0.3 mm long in the vertical direction. Horizontally, they extend over the width of the waveguide. The width of a given prism zone can be from approximately 3.0 to 150 mm in length, and consists of n units of prisms. These features will be better understood through the discussions below. As will be further described, the patterned output intensity shaping region 22 can be patterned in many different ways to improve the overall uniformity and output distribution of the light. In general, various embodiments of the output intensity shaping region 22 are achieved by patterning the major surfaces 32 of the output intensity shaping region 22 with a pattern of elongated groves that penetrate into the waveguide 14 such that the grooved pattern spoils the total internal reflection that would occur with a smooth or unpatterned surface, thus resulting in better and more uniform light distribution.

The waveguide 14 includes two sides or major surfaces 32. As described above, in addition to including one or more vertically oriented headlighting reduction regions 20, the waveguide 14 may be optimized to reduce light scattering and increase overall uniformity of light distribution by directing increased light to the floor and surrounding room through the output intensity shaping region 22. As used herein, each of the two “major surfaces” 32 refers to the sides of the waveguide 14 through which the vast majority of the light from the light source 12 is distributed into the surrounding environment (e.g., a room). The major surfaces 32 are the largest sides or surfaces of the waveguide 14. As illustrated, each of the major surfaces 32 of the of the output intensity shaping region 22 of waveguide 14 is patterned, as described further below. As will be appreciated, the scale of the patterns illustrated on the major surfaces 32 may be exaggerated for purposes of discussion and illustration.

In the embodiment illustrated in FIG. 3, the output intensity shaping region 22 is arranged below the headlighting reduction region 20. Thus, in the illustrated embodiment, the output intensity shaping region 22 can be said to be “separate from” or “independent of” the headlighting reduction region 20. As used herein, these terms do not connote that the regions are not a part of the same molded or machined waveguide 14, but rather that each region is arranged separately such that each region independently performs its respective function. In contrast, for embodiments wherein the headlighting reduction region 20 and the output intensity shaping region 22 are “integrated” within the waveguide 14, the functions of each section/region are integrated such that the collective effect is an improved waveguide 14 having more uniform light distribution and reduced headlighting.

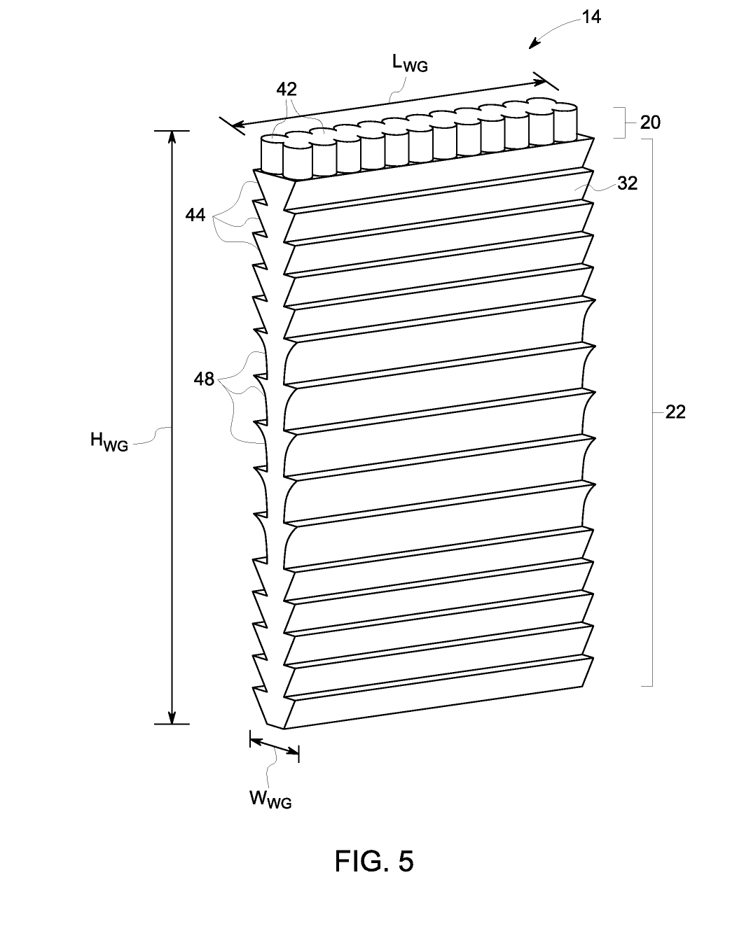

Turning now to FIG. 4, the headlighting effect is illustrated. As previously described, for lighting systems utilizing a linear array of LEDs 34 as the light source, the LEDs 34 may be arranged linearly with a center-to-center spacing that is larger than the size of the LEDs 34. That is, because the LEDs 34 are laterally discontinuous and there are small breaks between the LEDs 34, if a linear array of LEDs 34 is coupled into the narrow edge of a waveguide 36, and the sides of the waveguide 36 are patterned with micro-optical features, the luminous output from the waveguide 36 surface will exhibit banding or headlighting. Areas in line with an LED 34 will be brighter, as indicated by reference number 38. Conversely, areas between the LEDs 34 will be darker, as indicated by reference number 40. The observability of this phenomena will depend on the size of the emission area of the LEDs 34, the spacing between the LEDs 34, and the details of the surface patterning of the waveguide 36. Regardless, any observable headlighting is generally undesirable. Thus, embodiments of the invention provide a waveguide that is configured to reduce headlighting by forming secondary images within the waveguide to fill the undesirable gaps in output luminance that would otherwise appear between individual LEDs 34. More specifically, each of the waveguides 12 includes at least one headlighting reduction region 20 and previously described with regard to FIGS. 1-3 and as also described in the embodiments of FIGS. 5-10.

Turning now to FIG. 5, a perspective view of another embodiment of the waveguide 14 having a headlighting reduction region 20 and output intensity shaping region 22 is illustrated. As previously described, the waveguide 14 includes two major surfaces 32 that provide light to the surrounding environment. The waveguide 14 includes a length L_{WG}, a height H_{WG}, and a width W_{WG}. As used herein, the length L_{WG} refers to the horizontal dimension of the waveguide 14 as it runs the length parallel to a surface above, such as a ceiling, and below, such as a floor. It is the longest dimension of the waveguide 14. The height H_{WG} of the waveguide 14 refers to the vertical dimension of the waveguide 14 as it extends in the direction perpendicular to the surface above, such as the ceiling, and below, such as the floor. The width W_{WG} refers to the thickness of the waveguide 14 at its widest point and is the shortest dimension of the three dimensions (length L_{WG}, height H_{WG}, and width W_{WG}) of the waveguide 14.

The length L_{WG} of the waveguide 14, may be any desirable length, depending on the strength of the light source 12, the manufacturing capabilities for production of the waveguide 14 and the application in which the lighting system 10 is employed. In one embodiment, the length L_{WG} of the optically patterned waveguide 14 may be in the range of approximately 0.5-0.75 meters, such as 0.61 meters. As previously described, for certain applications, the lighting system 10 may employ multiple waveguides 14, such as three waveguides 14, aligned end-to-end to produce a total length of approximately 1.5-2.25 meters, for example.

The height H_{WG} of the waveguide 14 may also vary depending on the design of the lighting system 10. In one embodiment, the height H_{WG} of the waveguide 14 may be in the range of approximately 0.10-0.20 meters, such as 0.128 meters. Comparatively, the width W_{WG} of the waveguide 14 is relatively small. For instance in one embodiment the width W_{WG}, of the waveguide 14 maybe in the range of approximately 0.003-0.005 meters, such as 0.004 meters.

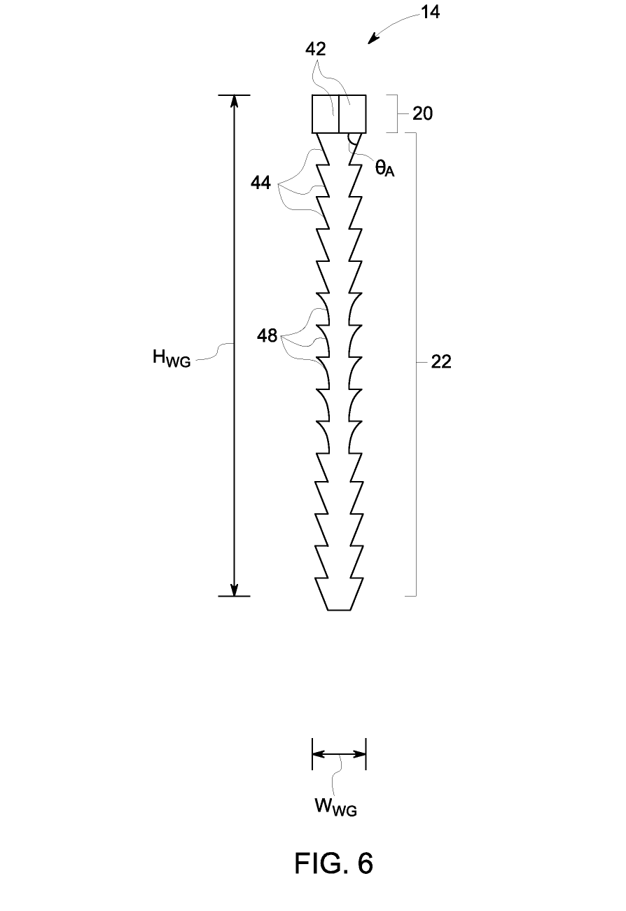

As previously described, the waveguide 14 includes at least one headlighting reduction region 20 and at least one output intensity shaping region 22. In the illustrated embodiment of FIG. 5, the headlighting reduction region 20 includes vertically oriented cylinders 42, as with the embodiment illustrated in FIG. 3. As illustrated, the headlighting reduction region 20 includes two rows of vertically oriented cylinders 42 that are arranged along approximately the entire length L_{WG} of the waveguide 14. As previously described, the upper portion of the waveguide 14 (here the headlighting reduction region 20) receives light from the light source 12 (not shown). As light passes through the cylinders 42 of the headlighting reduction region 20, secondary images are formed within the waveguide 14 to fill the gaps in output luminance emitted from the major surfaces 32 of the waveguide (i.e., fills the darker areas 40 illustrated in FIG. 4). After passing through the headlighting reduction region 20, the light passes into the area of the waveguide 14 below the headlighting reduction region 20, here the output intensity shaping region 22. Based on the patterning of the output intensity shaping region 22 of the waveguide 14, the output distribution from the lighting system 10 is improved. The output intensity shaping region 22 of the embodiment of FIG. 5 includes stacked planar trapezoidal prisms 44, as well as stacked radiused prisms 48. These features will be described in greater detail with regard to FIG. 6.

Turning now to FIG. 6, an end view of the waveguide 14 of FIG. 5 is illustrated. As previously described, the waveguide 14 has a height H_{WG} which depicts the vertical dimension of the waveguide 14, perpendicular to the ceiling and floor. Each major surface 32 of the waveguide 14 is patterned such that each of the two major surfaces 32 is configured to direct light in a downward and prescribed manner such the room is illuminated evenly through a wide area. The patterned waveguide 14 may be a plastic material such as an acrylate or polycarbonate, for example. Alternatively, the patterned waveguide 14 may comprise a glass material such as a BK7 or B270, for example. In accordance of one embodiment, the optical patterns on the waveguide 14 may be formed in a mold used to fabricate the waveguide 14 using any suitable molding techniques. Alternatively, the patterns may be formed through the waveguide 14 using a machining or laser process capable of accurately forming the optical patterns in the waveguide 14, as described further below. Alternately, the patterns can be 3D printed on the face of the plastic waveguide. Thus, the waveguide 14 may be machined or molded to create the various patterns in the headlighting reduction region 20 (here, the vertical cylinders 42) and the output intensity shaping region 22 (here, the stacked planar trapezoidal prisms 44 and the stacked radiused prisms 48

In accordance with embodiments described herein, the output intensity shaping region 22 of the optically patterned waveguide 14 has been optimized by patterning the major surfaces 32 of the optically patterned waveguide 14 with a pattern of elongated groves that form patterned prisms that penetrate into the waveguide 14 such that the grooved pattern spoils the total internal reflection that would occur with a smooth or unpatterned surface. The grooves extend through the entire length L_{WG} of the waveguide 14. By forming multiple elongated facets through the length L_{WG} and down the height H_{WG} of the waveguide 14, the brightness and uniformity distributed from the sides 32 of the patterned waveguide 14 can be optimized. In general, the facets on the major surfaces 32 can reflect the light traveling within the output intensity shaping region 22 of the waveguide 14 such that it exceeds the total internal reflection (TIR) condition on the opposite major surface 32 of the waveguide 14 after bouncing off the facet. That is to say that the light rays are deflected from their trajectory in a fashion that combines with each bounce off of a facet until it is incident at a high enough angle to transmit through the major surface 32 of the waveguide 14 on the opposite side of the facet that it was reflected from.

As described, various patterns have been tested and may be utilized to increase the uniformity and light distribution through the output intensity shaping region 22. In the embodiment illustrated in FIGS. 5 and 6, the output intensity shaping region 22 includes stacked planar trapezoidal prisms 44, as well as stacked radiused prisms 48. While each stack of prisms 44 and 48 includes five individual planar trapezoidal prisms 44 or radiused prisms 48, other numbers of individual prisms may be utilized. As used herein “planar trapeziodal prisms” refer to elongated prisms extending through the length L_{WG} of the waveguide 14 and having sides along the major surfaces 32 which taper in (as illustrated) or out in a linear fashion, such that the cross-section of each individual planar trapezoidal prism 44 resembles a trapezoid, when viewed at the edge along the width W_{WG} of the waveguide 14, as in FIG. 6. In one embodiment, the angle θ_{A} in which the planar sides of each trapezoidal prism 44 extends into the waveguide may be in the range of approximately 2 degrees-70 degrees and the side of each planar trapezoidal prism 44 may have a length in the range of approximately 0.015 mm to 0.2 mm.

As used herein “radiused prisms” refer to elongated prisms extending through the length L_{WG} of the waveguide 14 and having sides along the major surfaces 32 which are curved or “radiused”, such that the cross-section of each individual radiused prism 48 includes curved sides, when viewed at the edge along the width W_{WG} of the waveguide 14, as in FIG. 6. Further, each radiused prism 48 is etched into the waveguide such that the start and end of each curved side is a different vertical plane. In other words, the curved side begins at an edge of the waveguide 14 in a first vertical plane and curves inward (concave, as illustrated) or outward (convex) and ends in a second vertical plane, different from the first. Thus, a horizontal segment to each radiused prism 48 from the end of the curved side, returns the waveguide surface to the first vertical plan before the next radiused prism 48 (or planar trapezoidal prism 44) begins. In one embodiment the radius of curvature of each concave side of the radiused prisms 48 is in the range of approximately 0.5 to 5 mm. Alternatively, radiused prisms 48 having convex sides, when viewed at the edge along the width W_{WG} of the waveguide 14 may be utilized in alternative embodiments.

Modeling data and experimental data corresponding to physical prototypes produced in accordance with embodiments of the present invention were found to provide improved uniformity and brightness of light distribution toward the targeted areas compared with lighting systems using waveguides having either smooth surfaces, printed patterned surfaces, surfaces including random discrete geometric patterns, surfaces which are randomly roughened or surfaces that have not been enhanced in the manner described herein. These improvements are generally based on usage of various embodiments of the output intensity shaping region 22. Further, usage of various embodiments of the headlighting reduction region 20 has been demonstrated, through modeling data and/or experimental data, to improve the headlighting of the waveguide 14 by reducing the magnitude of luminance modulation of the light exiting the waveguide 14.

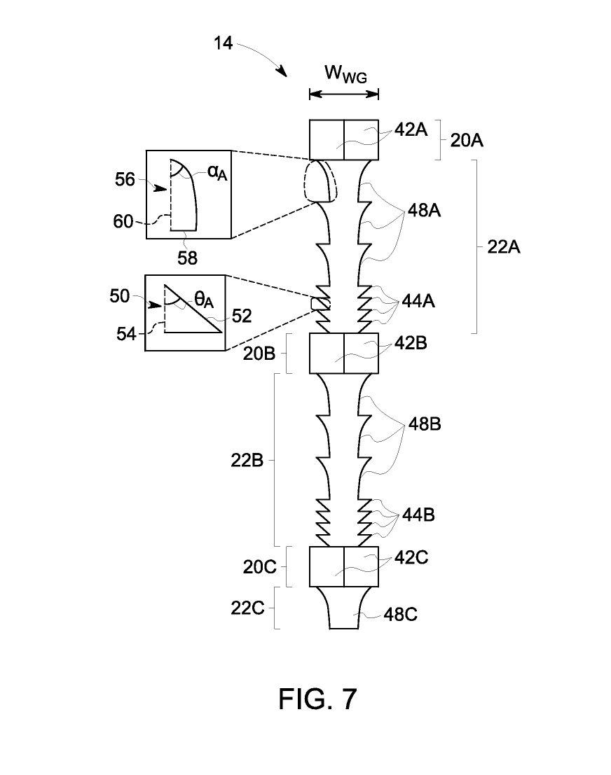

Referring now to FIG. 7, another embodiment of a waveguide 14 is illustrated. In the illustrated embodiment, the waveguide 14 includes three headlighting reduction regions 20A-20C and three output intensity shaping regions 22A-22C. As illustrated, each headlighting reduction region 20A-20C is independent of each output intensity shaping region 22A-22C. That is, each headlighting reduction region 20A-20C begins and ends before each intensity shaping region 22A-22C and thus these regions are not integral with each other.

In the illustrated embodiment, each headlighting reduction region 20A-20C includes two rows of vertically oriented cylinders 42A-42C. As previously described, the light from the light source 12 (not shown) enters the edge of the waveguide 14 at the first headlighting reduction region 20A. As the light passes through the headlighting reduction region 20A, secondary images of the lights (e.g., LEDs 30) are created within the waveguide 14 by reflections from the vertically oriented cylinders 42A before being passed through the waveguide 14 to the first output intensity shaping region 22A. These secondary images will aid in filling the gaps in output luminance from the major surfaces 32 of the waveguide 14, that would otherwise be created without the headlighting reduction region 20A. The headlighting reduction regions 20B and 20C, each having two rows of vertically oriented cylinders 42B and 42C, respectively, similarly create secondary images to fill the gaps in output luminance. I

In one embodiment, each cylinder 42A-42C has a vertical height in the range of approximately 10 mm-15 mm, such as 12 mm. Further, each cylinder 42A-42C may be spaced from an adjacent cylinder 42A-42C with a center-to-center distance in the range of approximately 0.1 mm-0.3 mm, such as 0.2 mm. Each cylinder 42A-42C may have a radius of curvature in the range of approximately 0.7 mm-0.8 mm, such as 0.74 mm. As will be appreciated, other dimensions are also contemplated.

In the embodiment of FIG. 7, the output intensity shaping region 22A includes a stack of three radiused prisms 48A and a stack of four planar trapezoidal prisms 44A. As previously described, each planar trapezoidal prism 44A refers to elongated prisms extending through the length L_{WG} of the waveguide 14 and having sides along the major surfaces 32 which taper in (as illustrated) or out (not illustrated) in a linear fashion, such that the cross-section of each individual planar trapezoidal prism 44A resembles a trapezoid, when viewed at the edge along the width W_{WG} of the waveguide 14, as in FIG. 7. An enlarged view 50 of the cutout section which defines the dimensions of each planar trapezoidal prism 44A is illustrated in FIG. 7. In one embodiment, the angle θ_{A} in which the planar sides of each trapezoidal prism 44A extends into the waveguide 14 may be in the range of approximately 60°-70°, such as 65° and the sloped side 52 of each zone of planar trapezoidal prisms 44A may have a length in the range of approximately 25 mm-30 mm, such as 28 mm. The vertical height of each planar trapezoidal prism 44A may be in the range of approximately −0.025-0.2 such as 0.05 mm.

The radiused prisms 48A of the output intensity shaping regions 22A resemble trapezoids with curved sides. That is, the “radiused prisms” 48A differ from planar trapezoidal prisms, such as the planar trapezoidal prisms 44A, in that while they do taper inward, the tapered side is curved, rather than planar. Further, as previously described, the sides of the radiused prisms 48A are curved, and the beginning and end of the curved tapered segment is not in the same vertical plane. Thus, rather than a smooth uniform curve starting and ending in the same vertical plane, the curved sides of the radiused prisms 48A begin in one vertical plane and end in another vertical plane within the waveguide 14. Consequently, a horizontal segment returns the waveguide to the outer vertical plane.

An enlarged view 56 of the cutout section which defines the dimensions of each radiused prism 48A is illustrated in FIG. 7, as well. In one embodiment, the angle α_{A} in which the curved sides of each radiused prism 48A extends into the waveguide 14 may be in the range of approximately 5°-10°, such as 8.5° and the width 58 of the cutout portion of each radiused prism 48A may be the range of approximately 300 μm-500 μm, such as 400 μm. In one embodiment, the vertical height 60 of each radiused prism zone 48A may be in the range of approximately 10 mm-15 mm, such as 12 mm. The height of a prismatic feature is in the 0.05 to 0.25 mm range. The radius of curvature of the cutout may be in the range of approximately 1.5 mm-2.0 mm, such as 1.74 mm.

As previously described, the embodiment of the waveguide 14 illustrated in FIG. 7 also includes a second output intensity shaping region 22B. The output intensity shaping region 22B may be identical to the output intensity shaping region 22A. Accordingly, the output intensity shaping region 22B includes a stack of three radiused prisms 48B and a stack for four planar trapezoidal prisms 44B. As will be appreciated, each of the radiused prisms 48B and planar trapezoidal prisms 44B have dimensions similar to those described above with reference to the radiused prisms 48A and planar trapezoidal prisms 44A, respectively. The illustrated waveguide 14 also includes a third output intensity shaping region 22C which includes a single radiused prism 48C, which has the same dimensions as each radiused prism 48A, described above.

It should be noted that while the embodiments illustrated in FIGS. 3 and 5-7 illustrate waveguides 14 wherein the patterned major surfaces 32, and particularly the output intensity shaping region 22, include features, such as various micro-prisms, that are stacked on top of each other, other embodiments may include vertical, unpatterned regions between adjacent prisms. For instance, in the embodiment of FIG. 7, there may be an unpatterned vertical region between the radiused prisms 48A and the planar trapezoidal prisms 44A. Alternatively, there may be unpatterned vertical regions of the waveguide 14 between each individual radiused prism 48A and/or each planar trapezoidal prism 44A. As will be appreciated, this pattern of unpatterned vertical regions may also be followed through the radiused prisms 48B and/or the planar trapezoidal prisms 44B. The length of the unpatterned vertical regions between various micro-prisms or sets of micro-prisms may be varied depending on the other features of the particular waveguide 14.

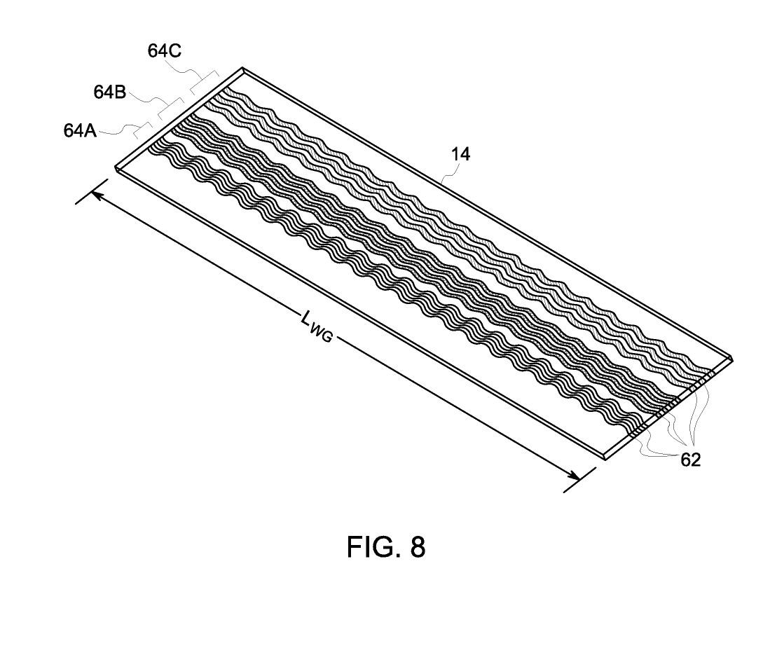

Turning now to FIG. 8, another embodiment of the waveguide 14 is illustrated. In the embodiment of FIG. 8, the waveguide 14 includes a high frequency modulation of the lateral position of the patterned surfaces of the waveguide 14. That is, in the illustrated embodiment, each of the patterned prisms 62 of the waveguide 14 have been formed in a sinusoidal pattern throughout the length L_{WG} of the waveguide 14. The lateral modulation pattern may have a length from 1 to 35 mm with an amplitude of 0.2-1.0 mm, for instance. While a sinusoidal pattern is illustrated, other periodic patterns may be contemplated. In the illustrated embodiment, there are three groupings 64A-64C of the patterned prisms 62. Each of the groupings 64A-64C may include stacked prisms, such as the planar trapezoidal prisms or radiused prisms described above that may also be fabricated with a high frequency periodic pattern (e.g., sinusoidal) through the length L_{WG} of the waveguide 14, as illustrated. Further, each independent patterned prism 62 and/or each group 64A-64C of patterned prisms 62 may include unpatterned vertical regions therebetween. The periodic pattern through each respective grouping 64A-64C may be the same or different from one another. In an alternative embodiment, the high frequency modulation through the waveguide may be in the vertical direction (i.e., height H_{WG}), rather than the lateral (horizontal) direction illustrated in FIG. 8.

Advantageously, the embodiment described with reference to FIG. 8 provides a waveguide 14, wherein the headlighting reduction region 20 and the output intensity region 22 are integral with one another, such that dual functions of diminished magnitude of luminance modulation of light (headlighting reduction) and improved light distribution in the surrounding environment occur through the same patterned area of the waveguide 14. For instance, the high frequency modulation of a periodic pattern (e.g., sinusoidal), e.g., a 0.5 to 3 mm period and a 0.02 to 0.4 mm in height, causes dispersion of light through the waveguide, while the linear ramp sections of the prisms provide improved output intensity distribution control.

In alternatives of the various embodiments described most particularly with regard to FIGS. 2, 3 and 5-7, waveguides 14 having integrated headlighting reduction regions 20 and output intensity shaping regions 22 may be utilized. Specifically, rather than including independent headlighting reduction regions 20 (e.g., vertical cylinders 42), the apex of the various prisms may be modified to include vertical concave cylindrical features. The apex of the individual prisms may be modified by a second machining step, for example. Advantageously, this embodiment provides an integrated waveguide 14, wherein the dual functions of diminished magnitude of luminance modulation of light (headlighting reduction) and improved light distribution in the surrounding environment occur through the same patterned area.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A waveguide comprising:
at least one headlighting reduction region configured to reduce the magnitude of luminance modulation from the waveguide; and
at least one output intensity shaping region configured to increase the uniformity of light distribution from the waveguide.

2. The waveguide of claim 1, wherein the at least one headlighting reduction region comprises a plurality of vertically oriented cylinders.

3. The waveguide of claim 1, wherein the at least one headlighting reduction region is arranged at a top of the waveguide and is configured to receive light directly from a light source.

4. The waveguide of claim 3, wherein the at least one output intensity shaping region is arranged vertically below the at least one headlighting reduction region such that light is received from the light source after passing through the at least one headlighting reduction region.

5. The waveguide of claim 1, wherein the at least one headlighting reduction region is integrated with the at least one output intensity shaping region.

6. The waveguide of claim 1, wherein the at least one output intensity shaping region comprises a plurality of planar trapezoidal prisms arranged in a vertical stack, wherein each of the plurality of trapezoidal prisms extends horizontally throughout the length of the waveguide.

7. The waveguide of claim 1, wherein the at least one output intensity shaping region comprises:
a first plurality of prisms having a first cross-sectional shape and arranged in a vertical stack, wherein each of the first plurality of prisms extends horizontally throughout the length of the waveguide; and
a second plurality of prisms having a second cross-sectional shape different from the first cross-sectional shape and arranged in a vertical stack, wherein each of the second plurality of prisms extends horizontally throughout the length of the waveguide.

8. The waveguide of claim 7, wherein the first plurality of prisms comprises planar trapezoidal prisms.

9. The waveguide of claim 8, wherein the second plurality of prisms comprises radiused prisms.

10. The waveguide of claim 1, wherein the at least one headlighting reduction region comprises a modulated periodic pattern integrated throughout a horizontal length of the at least one output intensity shaping region.

11. The waveguide of claim 1, wherein the at least one headlighting reduction region comprises a modulated periodic pattern integrated throughout a vertical length of the at least one output intensity shaping region.

12. A system comprising:
a light source; and
a waveguide arranged to receive light from the light source at a horizontally positioned surface and distribute the light through a vertically positioned surface, wherein the waveguide comprises at least one headlighting reduction region configured to reduce the magnitude of luminance modulation from the waveguide and at least one output intensity shaping region configured to increase the uniformity of light distribution from the waveguide.

13. The system of claim 12, wherein the light source comprises a plurality of linearly arranged light emitting diodes.

14. The system of claim 13, further comprising a mounting mechanism configured to couple the light source to an overhead structure.

15. The system of claim 12, wherein the waveguide is arranged perpendicular to a ceiling after installation of the system for usage.

16. The system of claim 12, wherein the length of the waveguide is in a range of 0.5-0.75 meters.

17. The system of claim 12, wherein the height of the waveguide is in a range of 0.10-0.20 meters.

18. The system of claim 12, wherein the width of the waveguide is in a range of 0.003-0.005 meters.

19. The system of claim 12, wherein the at least one headlighting reduction region comprises a plurality of vertically oriented cylinders.

20. The system of claim 12, wherein the at least one headlighting reduction region is arranged at a top of the waveguide and is configured to receive light directly from the light source.

21. The system of claim 12, wherein the at least one headlighting reduction region is integrated with the at least one output intensity shaping region.

22. The system of claim 12, wherein the at least one output intensity shaping region comprises a plurality of planar trapezoidal prisms arranged in a vertical stack, wherein each of the plurality of trapezoidal prisms extends horizontally throughout the length of the waveguide.

23. A method of providing general area lighting for a room, comprising:
emitting light from a light source into a patterned waveguide;
forming a plurality of secondary images of the light source within the waveguide;
reflecting at least some of the light within the waveguide off of patterned major surfaces of the waveguide; and
emitting the light from the patterned major surfaces of the waveguide into the room.

24. The method of claim 23, wherein emitting light from a light source comprises emitting light from a plurality of linearly arranged light emitting diodes (LEDs).

25. The method of claim 23, where forming the plurality of secondary images comprises reflecting the light, received from the light source, off of vertically oriented micro-optical features within the waveguide.

26. The method of claim 25, wherein forming the plurality of secondary images comprises reflecting the light, received from the light source, off of vertically oriented cylinders within the waveguide.

27. The method of claim 23, wherein reflecting at least some of the light within the waveguide comprises reflecting at least some of the light off of a plurality of prisms formed through the entire length of the waveguide.

28. The method of claim 23, wherein forming the plurality of secondary images of the light source within the waveguide occurs before reflecting at least some of the light within the waveguide off of the patterned major surfaces of the waveguide.
